(19) United States
(12) Patent Application Publication
(10) Pub. No.: US 2026/0352470 A1
(43) Pub. Date: Nov. 5, 2026

(54) DIGITAL TOKEN PROVISION SYSTEM, DIGITAL TOKEN PROVISION PROGRAM, AND DIGITAL TOKEN PROVISION METHOD

(71) Applicant: TEIJIN LIMITED, Osaka-shi, Osaka (JP)

(72) Inventors: Hiroshi OKAGAWA, Tokyo (JP); Kazune HARASHIMA, Tokyo (JP); Tsukasa KOBAYASHI, Tokyo (JP); Hiroyuki GOTO, Tokyo (JP); Go YOSHIDA, Tokyo (JP); Kiyoshi KOIKE, Tokyo (JP); Shizuka YOSHIZAKI, Tokyo (JP)

(73) Assignee: TEIJIN LIMITED, Osaka-shi, Osaka (JP)

(21) Appl. No.: 19/102,022

(22) PCT Filed: Aug. 8, 2023
(86) PCT No.: PCT/JP2023/028884

§ 371 Date: Feb. 7, 2025

(30) Foreign Application Priority Data
Aug. 9, 2022 (JP) 2022-127242

(51) Int. Cl. H04L 9/32; H04L 9/00

(52) U.S. Cl. CPC H04L 9/3213; H04L 9/50

(57) ABSTRACT

An object of the present invention is to provide a technique of providing proof of a user's visit as digital data using position information. A digital token provision system 1 that provides a digital token includes: a database 201; a reception means 202; a determination means 203; and a transmission means 204, in which the database 201 stores position information as a provision condition of a digital token, the reception means 202 receives a collation instruction including a current location of a user, the determination means 203 determines satisfaction of the provision condition by using a collation result of the position information and the current location, and the transmission means 204 transmits a provision instruction of a digital token to a blockchain network system 4 in a case where the provision condition is satisfied.

### TECHNICAL FIELD

The present invention relates to a digital token provision system, a digital token provision program, and a digital token provision method.

### BACKGROUND ART

Conventionally, there is a technique of visiting a place specified in advance by a provider and obtaining a Stamp or the like using position information.

Patent Literature 1 discloses a stamp rally system in which two-dimensional codes are installed to each of a plurality of facilities to be stamp points, and participants acquire stamps by reading each two-dimensional code by a handheld portable terminal. A stamp rally server is loaded with: a position information collation means for collating position information acquired by the portable terminal when the two-dimensional code is read and set position information set to the two-dimensional code; and a stamp issue means for displaying a stamp book on a screen of the portable terminal and issuing the stamp when the position information match, and wide range common set position information including set position information of at least a plurality of two-dimensional codes is used as the set position information of at least the plurality of two-dimensional codes.

### CITATION LIST

### Patent Literature

Patent Literature 1: JP 2020-161022 A

### SUMMARY OF INVENTION

### Technical Problem

In Patent Literature 1, a provider of a stamp rally specifies a facility to which a stamp is to be given in advance, and a user can receive the provision of the stamp by going to visiting facility. Therefore, the user has not been able to select a place by himself/herself and obtain proof of visiting a specific place as digital data.

In view of the above circumstances, an object of the present invention is to provide a technique of providing proof of a user's visit as digital data using position information.

### Solution to Problem

[1] A digital token provision system that provides a digital token, the digital token provision system including:
a database; a reception means; a determination means; and a transmission means, in which
the database stores position information as a provision condition of a digital token,
the reception means receives a collation instruction including a current location of a user,
the determination means determines satisfaction of the provision condition by using a collation result of the position information and the current location, and
the transmission means transmits a provision instruction of a digital token to a blockchain network system in a case where the provision condition is satisfied.

In this manner, by collating the position information with the current location of the user and transmitting the provision instruction of the digital token to the blockchain network system, the present invention enables provision of the digital token that allows identification of the user who has received the provision.

[2] The digital token provision system according to [1], in which
the database further stores at least one of an acquisition order, an acquisition count, or an acquirable period as a provision condition of the digital token,
the acquisition order is an order of position information that needs to be collated in order to acquire the digital token or an acquisition order of a digital token that needs to be acquired,
the acquisition count is a count of position information that needs to be collated in order to acquire the digital token or an acquisition count of the digital token that needs to be acquired,
the acquirable period is a period in which the digital token is acquirable, and
the determination means further determines satisfaction of the provision condition by using at least one of a collation history of the position information of the user and the acquisition order, the collation history of the position information of the user and the acquisition count, an acquisition history of the digital token of the user and the acquisition order, the acquisition history of the digital token of the user and the acquisition count, or the collation result of current date and time and the acquirable period.

As a result, it is possible to set the provision condition of the digital token having a high acquisition difficulty.

[3] The digital token provision system according to or [2], further including:
a reservation reception means, in which the reservation reception means receives a reservation for provision of a digital token, and
the determination means determines satisfaction of the provision condition by using a collation result of position information of the digital token for which the reservation has been received and the current location.

As a result, the user can reserve provision of the digital token.

[4] The digital token provision system according to any one of [1] to [3], further including:
a current location transmission means, in which
the database further includes an acquirable time as a provision condition of the digital token, and
the current location transmission means transmits the current location to the reception means at the acquirable time.

As a result, the user can automatically transmit the current location to receive provision of the digital token that can be acquired at a specific time.

[5] The digital token provision system according to any one of [1] to [4], further including:
a selection reception means; and a display processing means, in which
the selection reception means receives selection for the digital token, and
the display processing means performs display processing of the provision condition of the selected digital token.

As a result, the user can confirm the provision condition of the digital token.

[6] The digital token provision system according to [2] or any one of [3] to [5] citing [2], further including:
a display processing means, in which
the determination means determines the satisfaction of the provision condition of the digital token on a basis of at least one of the collation history of the position information of the user and the acquisition order, the collation history of the position information of the user and the acquisition count, the acquisition history of the digital token of the user and the acquisition order, the acquisition history of the digital token of the user and the acquisition count, or the collation result of the current date and time and the acquirable period, and
the display processing means performs display processing of a provision request section of the digital token in a differentiated manner based on a satisfaction status of the provision condition.

As a result, the user can easily determine the digital token that the user can currently acquire.

[7] The digital token provision system according to any one of [1] to [6], in which
the database further stores, as the provision condition of the digital token, information acquired by reading of a two-dimensional code or connection of near field communication, and
when the reception means receives a collation instruction including the information acquired by reading of a two-dimensional code by the user or connection of near field communication,
the determination means determines satisfaction of the provision condition by using a collation result between the information stored in the database and the information acquired by the reception means.

As a result, it is possible to set the provision condition of the digital token having a high acquisition difficulty.

[8] The digital token provision system according to any one of [1] to [7], in which
the database further stores digital content to be provided to a user in association with position information,
the digital content is an image or a video, and
the transmission means transmits, to the blockchain network system, the provision instruction including the digital content or a Uniform Resource Identifier (URI) that allows browsing of the digital content in a case where the provision condition is satisfied.

As a result, the image or the video related to a specific place can be provided to the user who collates the position information.

[9] The digital token provision system according to [8], further including:
a combined information reception means; and a display processing means, in which
the combined information reception means further receives combined information,
the database stores the combined information in association with a URI for browsing the digital content,
the combined information is a date, a text, or handwritten data freely drawn by the user, and
when receiving a display processing request of the digital content directly or indirectly by using the URI, the display processing means transmits a display processing result of the digital content in which the combined information is combined, on a basis of the digital content and the combined information.

As a result, the user can record the date, the text, or the handwritten data freely drawn by the user.

[10] The digital token provision system according to [8], further including:
a combined information reception means; and a combining means, in which
the combined information reception means further receives combined information,
the combining means creates combined digital content obtained by combining the digital content and the combined information,
the combined information is a date, a text, or handwritten data freely drawn by the user, and
after the combining, the transmission means transmits, to a blockchain network system, the provision instruction including the combined digital content or the URI that allows browsing of the combined digital content.

As a result, the user can record the date, the text, or the handwritten data freely drawn by the user.

[11] The digital token provision system according to any one of [1] to [10], further including:
a user-provided data reception means, in which
the user-provided data reception means receives user-provided data,
the user-provided data is at least one of text, a photograph, or a video, and
the transmission means further transmits, to the blockchain network system, the provision instruction including the user-provided data or a URI that allows browsing of the user-provided data in a case where the provision condition is satisfied.

As a result, the user can record the photograph and the video of a place where the user has visited.

[12] The digital token provision system according to any one of [1] to [11], further including:
a pre-transfer reception means; and a transfer transmission means, in which
from a proxy user who collates a current location with the position information as proxy for someone, the pre-transfer reception means receives a transfer destination user, who desires to receive transfer in advance, and a digital token, which the proxy user desires to transfer to the transfer destination user, among providable digital tokens, and
the transfer transmission means transmits a provision instruction of the digital token to the blockchain network system in a case where the provision condition is satisfied.

As a result, the user can collate the current location with the position information as proxy, and transfer the digital token.

[13] The digital token provision system according to any one of [1] to [12], further including:
a retrieval means; and a notification means, in which
the retrieval means retrieves peripheral position information on a basis of a current location of the user and position information indicating a provision condition of the digital token,
the peripheral position information is position information of a digital token provided around the current location of the user, and
the notification means notifies the user of the peripheral position information.

As a result, the user can easily learn the digital token that can be acquired around the current location of the user.

[14] The digital token provision system according to [13], in which
the database further stores an attribute specified by the user and an attribute associated with each digital token, and
the retrieval means further retrieves peripheral position information on a basis of the current location of the user, the attribute specified by the user, the position information indicating the provision condition of the digital token, and the attribute associated with each digital token.

As a result, the user can easily learn the digital token that is around the current location of the user and that the user is highly likely to be interested in.

[15] The digital token provision system according to [13], in which
the database further stores a user attribute of the user in association with the digital token each time the user collates the position information or acquires the digital token, and
when a certain user retrieves the peripheral position information, the retrieval means further retrieves the peripheral position information on a basis of a current location and a user attribute of the certain user.

As a result, the user can easily learn the digital token that is around the current location of the user and that the user is highly likely to be interested in.

[16] The digital token provision system according to any one of [13] to [15], in which
the database further stores description information in association with the digital token,
the description information is an advertisement of the digital token or a text, an image, or a video for description, and
the notification means further notifies the user of the description information.

As a result, the user can in detail and conveniently learn details of the digital token that is present around the current location of the user.

[17] The digital token provision system according to any one of [1] to [16], further including:
a payment determination means, in which
the provision condition includes success or failure of payment,
the payment determination means determines success or failure of payment made by the user, and
the transmission means transmits the provision instruction of the digital token to the blockchain network system in a case where the provision condition is satisfied.

As a result, the digital token that requires payment can be provided in a case where the payment is completed.

[18] The digital token provision system according to [17], in which
the payment determination means further determines satisfaction of payment made by the user, and provides receipt data in a case where the payment is satisfied, and
the transmission means further transmits, to the blockchain network system, the provision instruction including the receipt data or a URI that allows browsing of the receipt data.

As a result, a receipt can be issued after payment is made.

[19] The digital token provision system according to any one of [1] to [18], further including:
a payment determination means; and a display processing means, in which
the payment determination means determines whether or not payment made by the user is possible, and
the display processing means performs display processing of a provision request section of the digital token so as to distinguish between a case where the payment made by the user is possible and a case where the payment is impossible.

As a result, the user can easily determine the digital token that the user cannot currently acquire due to the impossibility of completing payment.

[20] The digital token provision system according to any one of [1] to [19], further including:
a certificate provision means, in which
the certificate provision means provides certificate data indicating that a user holds a digital token, and
the transmission means further transmits, to the blockchain network system, the provision instruction including the certificate data or a URI that allows browsing of the certificate data.

As a result, the user can prove that the user has held a certain digital token in the past.

[21] The digital token provision system according to any one of [1] to [20], in which
the digital token is a non-fungible token.

As a result, it is possible to provide digital data that is difficult to falsify.

[22] A digital token provision program for providing a digital token, the digital token provision program causing a computer to function as:
a database; a reception means; a determination means; and a transmission means, in which
the database stores in advance a provision condition of a digital token including position information,
the reception means receives a collation instruction including a current location of a user,
the determination means determines satisfaction of the provision condition by using a collation result of the position information and the current location, and
the transmission means transmits a provision instruction of a digital token to a blockchain network system in a case where the provision condition is satisfied.

[23] A digital token provision method for providing a digital token, the method comprising:
by a digital token provision system including a database, executing: a reception step; a determination step; and a transmission step, in which
the database stores in advance a provision condition of a digital token including position information,
in the reception step, a collation instruction including a current location of a user is received,
in the determination step, satisfaction of the provision condition is determined by using a collation result of the position information and the current location, and
in the transmission step, a provision instruction of a digital token is transmitted to a blockchain network system in a case where the provision condition is satisfied.

### Advantageous Effects of Invention

The present invention can provide a technique of providing proof of a user's visit as digital data using position information.

### BRIEF DESCRIPTION OF DRAWINGS

FIG. 1 is a configuration diagram of a digital token provision system according to the present embodiment.

FIG. 2 is a hardware configuration diagram of a server and a user terminal of the digital token provision system according to the present embodiment.

FIG. 3 is a functional block diagram of the server and the user terminal of the digital token provision system according to the present embodiment.

FIG. 4 illustrates an example of a database of digital token information according to the present embodiment.

FIG. 5 illustrates an example of the database of the digital token information according to the present embodiment.

FIG. 6 illustrates an example of a database of user history information and user-provided information according to the present embodiment.

FIG. 7 illustrates an example of a flow of processing of providing a digital token in the present embodiment.

FIG. 8 illustrates an example of a flow of processing of collating a current location and position information and transferring a digital token via a user as a proxy in the present embodiment.

FIG. 9 illustrates an example of a flow of processing of reserving provision of a digital token including an acquirable time as a provision condition in the present embodiment.

FIG. 10 illustrates an example of a flow of processing of retrieving, notifying, and displaying peripheral position information in the present embodiment.

### DESCRIPTION OF EMBODIMENTS

Hereinafter, a digital token provision system according to an embodiment of the present invention will be described with reference to the drawings. Note that the following embodiment is an example of the present invention, and the present invention is not limited to the following embodiment, and various configurations can be adopted.

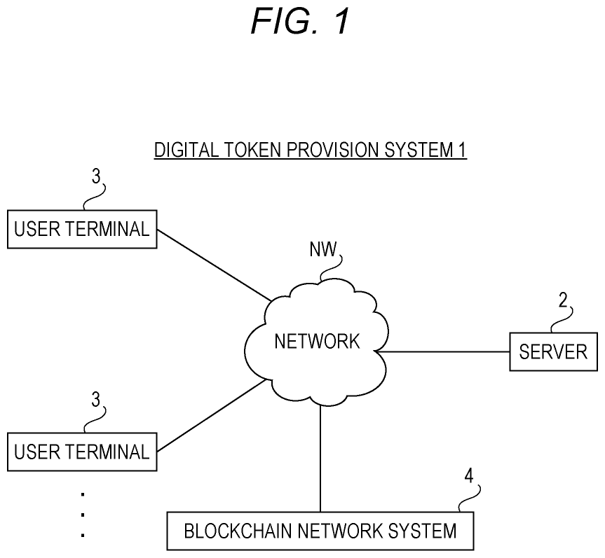

FIG. 1 is a configuration diagram of the digital token provision system according to the present embodiment. As illustrated in FIG. 1, a digital token provision system 1 according to the present embodiment is configured such that a server 2, a user terminal 3, and a blockchain network system 4 can communicate with each other via a communication network NW such as the Internet. Then, the current location of the user transmitted by the user terminal 3 is collated with the position information of a specific place stored in the server 2, and in a case where a collation result including the collation between the current location and the position information satisfies a provision condition of the digital token, a provision instruction of the digital token is transmitted to the blockchain network system 4. Furthermore, the current location transmitted by the user terminal 3 may be a current location in a virtual space, and even in this case, coordinates or the like indicating the current location in the virtual space is transmitted via the user terminal 3.

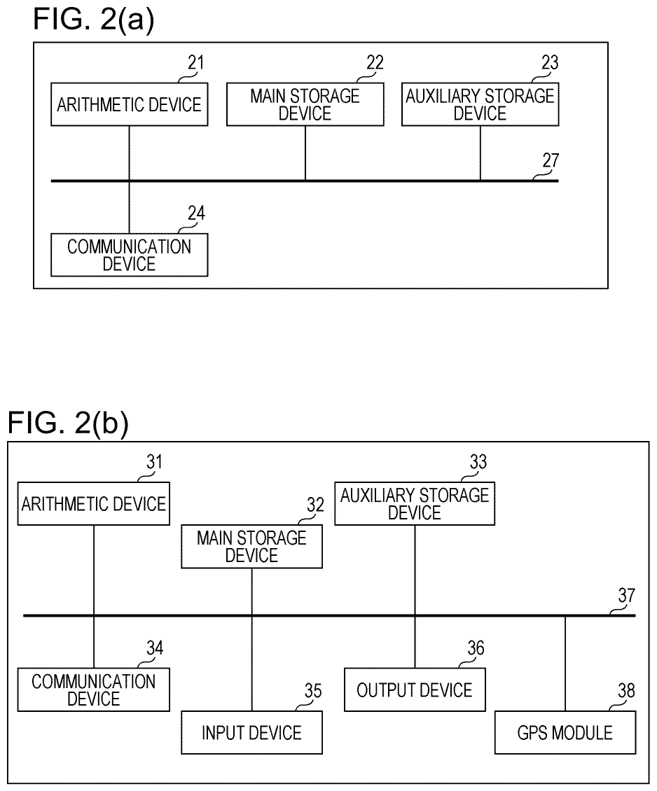

FIG. 2 is a hardware configuration diagram of the server and the user terminal of the digital token provision system according to the present embodiment. FIG. 2(a) is a hardware configuration diagram of the server 2. The server 2 has a data communication function, and includes, as hardware components, an arithmetic device 21 such as a CPU, a main storage device 22 such as a random access memory (RAM) as a working memory, an auxiliary storage device 23 such as a hard disk drive (HDD), a solid state drive (SSD), or a flash memory, a wired or wireless communication device 24 for realizing connection to the communication network NW, and a bus 27 for connecting each component. As the server 2, a general-purpose server computer, a personal computer, or the like can be used. Furthermore, the auxiliary storage device 23 stores an operating system (OS), a digital token provision program that exerts its function in cooperation with the operating system, various types of information (including data), and the like.

FIG. 2(b) is a hardware configuration diagram of the user terminal 3. The user terminal 3 includes an arithmetic device 31, a main storage device 32, an auxiliary storage device 33, a communication device 34, an input device 35 using a keyboard, a mouse, a touch panel, or the like, an output device 36 using a display, a speaker, or the like, a bus 37, a GPS module 38, or the like. As the user terminal 3, a personal computer, a smartphone, a tablet terminal, a wearable device, or the like can be used. The auxiliary storage device 33 stores an operating system, a digital token management program, and the like. Furthermore, the input device 35 includes a reading device capable of reading a two-dimensional code such as a QR code (registered trademark).

The blockchain network system 4 includes a plurality of nodes that store blockchains. The blockchain is an aspect of a distributed ledger, and may be a public chain, a private chain, or the like.

Note that the blockchain is originally used as a distributed ledger in bitcoin, which is virtual currency, and includes a large number of nodes. However, here, for simplicity of description, a single component as illustrated in FIG. 1 is shown. In the present embodiment, ETH, NESTA, or the like can be used as the blockchain.

The blockchain is configured by a chain of data called a block. Since each block includes information of a hash value of the previous block, in a case where any block is falsified, an inconsistency occurs in the chain relationship. Furthermore, there is a characteristic that such unauthorized falsification processing, block deletion, and the like cannot be performed by a large number of nodes.

In the present embodiment, the digital token is a non-fungible token, and a smart contract is used to issue and transfer the non-fungible token.

In the present embodiment, the communication network NW is an Internet Protocol (IP) network. However, the type of the communication protocol is not limited, and the type and scale of the network are also not limited.

In the present embodiment, as an example, a case where the user terminal 3 is a smartphone and a dedicated application (digital token management program) is installed in the smartphone will be described. The user can confirm the digital token that can be provided to the user and the provision condition thereof in the dedicated application downloaded to the smartphone of the user. Furthermore, in the dedicated application, a collation instruction including the current location of the user is transmitted to the server 2, for example, by pressing a button displayed by selecting a digital token or the like.

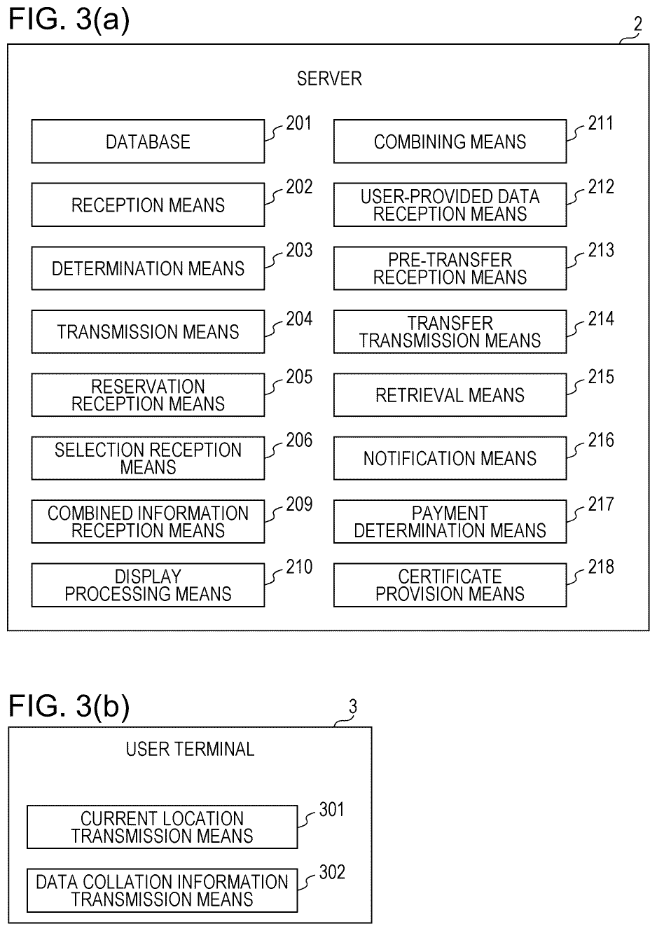

FIG. 3 is a functional block diagram of the server and the user terminal of the digital token provision system according to the present embodiment. As illustrated in FIG. 3(a), the server 2 includes a database 201, a reception means 202, a determination means 203, a transmission means 204, a reservation reception means 205, a selection reception means 206, a combined information reception means 209, a display processing means 210, a combining means 211, a user-provided data reception means 212, a pre-transfer reception means 213, a transfer transmission means 214, a retrieval means 215, a notification means 216, a payment determination means 217, and a certificate provision means 218.

As illustrated in FIG. 3(b), the user terminal 3 includes a current location transmission means 301 and a data collation information transmission means 302.

### Database

The database 201 includes user basic information, digital token information, user history information, and user-provided information.

### User Basic Information

The user basic information is basic information regarding a user who uses the digital token provision system, and in the present embodiment, general user information including a user ID, a password, a name of the user, a nickname, an address, a telephone number, a payment method, a wallet address of the user, and the like is stored. The user can specify an arbitrary attribute from digital token attributes to be described later. The user basic information may include a digital token attribute specified by the user.

### Digital Token Information

The digital token information is information regarding a digital token to be provided to the user, and a provision condition thereof is set in at least a part of the digital token provided to the user. In the present embodiment, as the provision condition of the digital token, position information for collating the current location of the user is associated with the digital token.

Furthermore, as the provision condition of the digital token, instead of or in addition to the position information, one or more of an acquisition order, an acquisition count, and an acquirable period may be associated with the digital token. The acquisition order is the order of the position information that needs to be collated in order to acquire the digital token or the acquisition order of the digital token that needs to be acquired. The acquisition count is a count of position information that needs to be collated in order to acquire the digital token or an acquisition count of the digital token that needs to be acquired. The acquirable period is a period in which the digital token can be acquired, and may be a year unit such as “2022 to 2032”, a month unit such as “June to August”, a day unit such as “January 1 to 3”, a time unit such as “11:00 to 13:00”, a minute unit such as “6:00 to 6:30”, or the like.

Furthermore, as the provision condition of the digital token, instead of or in addition to the position information, information used for data collation may be associated with the digital token. The information used for data collation is, for example, information acquired via a device capable of reading a two-dimensional code arranged at a place where a digital token can be acquired or connecting near field communication. The two-dimensional code is a QR code (registered trademark), Aztec Code, or the like, and the format thereof is not specified. The near field communication is Bluetooth (registered trademark), near field communication (NFC), or the like, and the format thereof is not specified.

Furthermore, as the provision condition of the digital token, instead of or in addition to the position information, an acquirable time may be associated with the digital token. The acquirable time is a time when the digital token can be acquired, and the digital token cannot be acquired unless the current location is transmitted at that time.

The digital token information includes digital content associated with the digital token. The digital content is an image or a video for which the digital token represents an ownership right, a viewing right, or the like.

The digital token information may include a digital token attribute. The digital token attribute is an attribute indicating a type, a category, or the like of a place associated with the digital token. For example, the digital token related to the Zojoji temple includes the digital token attribute “temple”.

The digital token information may include description information. The description information is information regarding an advertisement or description regarding the digital token, and is text, an image, or a video.

### User History Information

The user history information is information regarding a history of the user who uses the digital token provision system. In the present embodiment, the user history information is the position information with which the user collates the current location, the date and time of the collation, the digital token provided to the user, and the date and time of the provision. In addition, a history of the digital token for which the user confirms the provision condition using a dedicated application may be included.

### User-Provided Information

The user-provided information is data provided by the user, and is combined information or user-provided data. The combined information is a date, a text, or handwritten data freely drawn by the user. The date may not be provided by the user. The text may either be input by the user or prepared in advance by a person other than the user and selected by the user. The file format of the text is TXT, Rich Text Format (RTF), or the like, and the format thereof is not specified. The file format of the handwritten data is JPEG, PNG, or the like, and is not specified. The user-provided data is text, a photograph, and a video provided by the user, and file formats thereof are not specified. In the present embodiment, the combined information is stored in association with the digital content provided to the user. In addition to this, a form is considered in which combined digital content obtained by combining the combined information with the digital content provided to the user or URI thereof is stored. The user-provided data is associated with the digital token provided to the user.

### Database Example

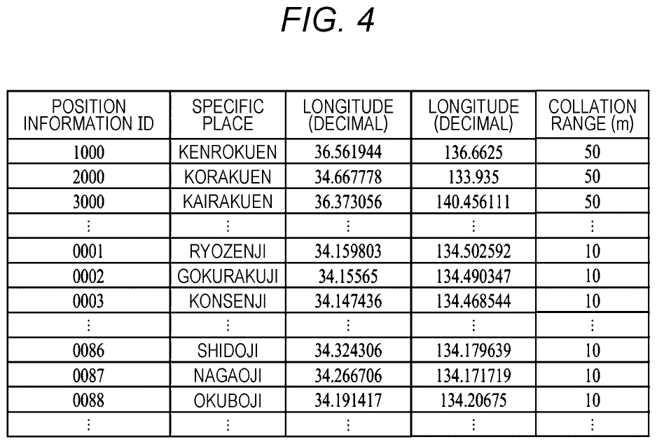

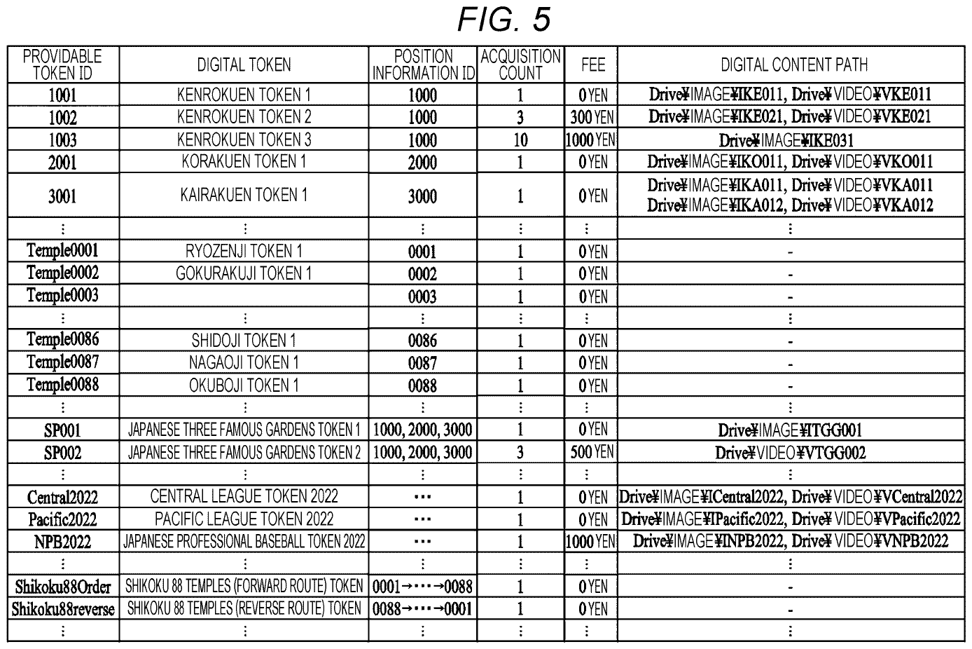

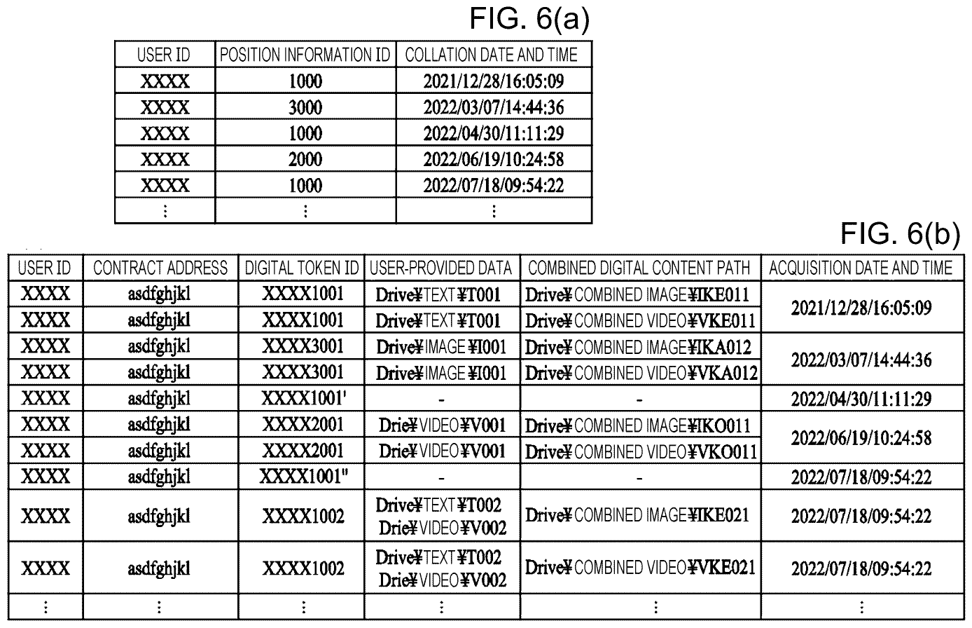

FIGS. 4 to 6 are examples of a database of the digital token provision system according to the present embodiment. FIGS. 4 and 5 are examples of a database of the digital token information according to the present embodiment. FIG. 6 is an example of the user history information and the user-provided information in the present embodiment.

As illustrated in FIG. 4, the database 201 stores a name of a specific place, position information of the place, and a collation range in association with the position information ID. The position information of the present embodiment is latitude and longitude, and is stored in decimal format. In addition, the data may be stored in sexagesimal format. Information other than latitude and longitude may be stored as the position information as long as the information enables collation between a specific place and the current location of the user. Furthermore, a collation range in the present embodiment is stored to determine whether the collation performed within a radius of a certain number of meters from the stored latitude and longitude is considered successful. In addition, a plurality of combinations of latitude and longitude at three or more points may be stored in advance, and collation may be performed within the range.

As illustrated in FIG. 5, the database 201 stores a name and a position information ID of a digital token to be provided, a provision condition of the digital token, digital content for which an ownership right and the like are defined by the digital token, and the like in association with a providable token ID capable of specifying a providable digital token.

As illustrated in FIG. 5, the database 201 stores position information, the acquisition count, or a fee as an example of the provision condition of the digital token. For example, in FIG. 5, “3” of the acquisition count of the Kenrokuen token 2 means that it is necessary to collate the information with the position information having the position information ID of 1000 three times. In the case of storing the acquisition count of the digital token that needs to be acquired, as the acquisition count of the Kenrokuen token 2 in FIG. 5, it is only required to store which token is acquired and how many times the token is acquired to acquire the Kenrokuen token 2, such as “Kenrokuen token 1 three times”. Note that the acquisition count may be the number of times of visits to a specific place defined by position information data or the like.

As illustrated in FIG. 5, the database 201 stores the acquisition order in the position information ID. For example, in FIG. 5, The position information ID “0001-> . . . 0088” for the Shikoku 88 Temples (forward route) token means that it is necessary to perform collation with the position information having the position information ID of 0001 first, followed by 0002, . . . , then 0087, and finally the position information having the position information ID of 0088. In a case where the order of acquisition of the digital tokens that need to be acquired is stored, a form such as “Temple0001-> . . . ->Temple0088” is conceivable in which providable tokens ID are sequentially stored as the acquisition order of the Shikoku 88 Temples (forward route) tokens.

In the present embodiment, the user can optionally select acquisition of the digital content. In addition, a form is conceivable in which when the user acquires a digital token, digital content associated with the digital token is automatically provided. In this case, when the user acquires a digital token having the same name, digital content associated with the digital token may not be provided for the second and subsequent times. In addition to these, a form is also conceivable in which a provision condition is set for each digital content and the user can acquire the digital content in a case where the provision condition is satisfied. Furthermore, as the provision condition of the digital content, a condition similar to that of the digital token is conceivable.

As illustrated in FIG. 6(a), the database 201 stores the position information ID collated by the user and collation date and time indicating the date and time of the collation in association with the user ID that allows identification of the user. In this manner, by storing the position information ID and the collation date and time in association with the user ID, the server 2 can collate the acquisition order, the acquisition count, the acquirable period, and the like.

As illustrated in FIG. 6(b), the database 201 records the digital token (acquired digital token) acquired by the user in association with the user ID. In the present embodiment, a contract address and a digital token ID, user-provided data which is data provided by the user, a path of combined digital content obtained by combining digital content acquired by the user and combined information, and acquisition date and time indicating date and time when the user acquired the digital token and the digital content are stored in the user ID. In this manner, by storing the path of the combined digital content in association with the user ID, the server 2 can perform display processing of the combined digital content. In this manner, by storing the digital token ID and the acquisition date and time in association with the user ID, the server 2 can collate the acquisition order, the acquisition count, the acquirable period, and the like.

### Reception Means

When receiving a collation instruction including the current location of the user, the reception means 202 transmits the collation instruction to the determination means 203. The current location of the user can be received via the user terminal 3.

The reception means 202 may receive a collation instruction including information used for data collation. The received information is transmitted to the determination means 203. The information used for data collation can be received via the user terminal 3. It is conceivable that the information used for data collation is, for example, a unique character string. The user acquires a unique character string from a two-dimensional code, and the reception means 202 receives the character string.

### Determination Means

When receiving the collation instruction including the current location of the user from the reception means 202, the determination means 203 determines satisfaction of the provision condition by using the collation result of the position information and the current location. In a case where the provision condition is satisfied, the determination means 203 transmits the fact to the transmission means 204. Furthermore, the collation date and time or the like may be stored in the database 201 in association with the user ID. The position information to be collated is stored within a certain range, and when the current location of the user is within the range, the collation is considered to be successful.

The determination means 203 may determine the satisfaction of the provision condition by using at least one of the collation history of the position information of the user and the acquisition order, the collation history of the position information of the user and the acquisition count, the acquisition history of the digital tokens of the user and the acquisition order, the acquisition history of the digital token of the user and the acquisition count, or the collation result of current date and time and the acquirable period. In a case where the provision condition is satisfied, the determination means 203 transmits the fact to the transmission means 204. Furthermore, the collation date and time or the like may be stored in the database 201 in association with the user ID. The collation history of the position information of the user is a history of the position information collated by the user in the past, and includes a collated date and time. The collation history of the position information of the user is as illustrated in FIG. 6(a). As a result, the order and the count of the position information collated by the user in the past are obtained. The acquisition history of the digital token is a history of digital token acquired by the user in the past, and includes an acquired date and time. As a result, the order and the count of the digital tokens acquired by the user in the past are obtained.

When receiving the collation instruction including the information used for the data collation from the reception means 202, the determination means 203 may determine the satisfaction of the provision condition by using the collation result of the information used for the data collation. In a case where the provision condition is satisfied, the determination means 203 transmits the fact to the transmission means 204. Furthermore, the collation date and time or the like may be stored in the database 201 in association with the user ID. For example, in the determination means 203, a form is conceivable to collate the unique character string received by the reception means 202 with the character string stored in the database 201.

### Transmission Means

In a case where the determination means 203 determines that the provision condition is satisfied, the transmission means 204 transmits a provision instruction of the digital token to the blockchain network system. Furthermore, the digital token to be provided to the user, the acquisition date and time, and the like may be stored in the database 201 in association with the user ID. The provision instruction includes a wallet address of the user, a contract address, metadata, and the like. The wallet address of the user and the contract address are stored in the blockchain in association with the token URI. The token URI is a URI for referring to metadata of a digital token, and indicates a storage location of metadata such as a server or an interplanetary file system (IPFS). Note that the server may be the server 2. The metadata is a name of the digital token, a description, user-provided data, digital content, combined information, receipt data, certificate data, or the like, or a metadata URI that allows browsing of them. The metadata itself may be stored in the blockchain. When storing the processing result based on the provision instruction, the blockchain returns the fact to the server 2.

When the determination means 203 determines that the provision condition is satisfied, the transmission means 204 may transmit, to the blockchain network system, a provision instruction including digital content or a URI that allows browsing of the digital content. The digital content is an image or a video. The file format of the image is Joint Photographic Experts Group (JPEG), Portable Network Graphics (PNG), Graphics Interchange Format (GIF), or the like, and is not specified. The video file is MP4, MOV, or the like, and the format thereof is not specified.

The transmission means 204 may combine the digital content and the combined information by the combining means 211 to be described later, and then transmit, to the blockchain network system, a provision instruction including the combined digital content or a URI that allows browsing of the combined digital content.

The transmission means 204 may transmit, to the blockchain network system, a provision instruction including user-provided data or a URI that allows browsing of the user-provided data. Furthermore, the user-provided data or the URI that allows browsing of the user-provided data may be stored in the database 201 in association with the digital token to be provided to the user.

The transmission means 204 may transmit, to the blockchain network system, a provision instruction including receipt data or a URI that allows browsing of the receipt data. Furthermore, the receipt data or the URI that allows browsing of the receipt data may be stored in the database 201 in association with the digital token to be provided to the user. The receipt is a general receipt to be provided when a user makes a payment. The address of the receipt may be either a name in user basic information or a name newly received from the user.

The transmission means 204 may transmit, to the blockchain network system, a provision instruction including certificate data or the URI that allows browsing of the certificate data. Furthermore, the certificate data or the URI that allows browsing of browsing the certificate data may be stored in the database 201 in association with the digital token to be provided to the user. The certificate is to prove that the user has possessed the digital token in the past. The certificate data may include information in user basic information such as a user ID and a name of the user, and a date of acquisition by the user. Furthermore, the certificate data may include user-provided information.

### Reservation Reception Means

The reservation reception means 205 receives a reservation from the user for provision of a digital token.

### Current Location Transmission Means

The current location transmission means 301 transmits, to the reception means 202, the current location of the user acquired via the GPS module 38. Furthermore, in a case where an acquirable time is included in the provision condition of the digital token for which the reservation for provision has been received by the reservation reception means 205, the current location transmission means 301 may automatically transmit the current location of the user to the reception means 202 at the acquirable time.

### Data Collation Information Transmission Means

The data collation information transmission means 302 transmits information used for data collation to the reception means 202.

### Display Processing Means

The display processing means 210 receives a display processing request for various screens from the user and returns a display processing result. In the present embodiment, the display processing means 210 performs display processing on a providable digital token and displays a provision request screen. Furthermore, a provision request section of the digital token is displayed on the provision request screen. When the user presses the provision request section, a collation instruction is transmitted to the reception means 202.

The display processing means 210 causes a user basic information management screen that allows editing of the user basic information to be displayed.

Furthermore, the display processing means 210 performs display processing on the digital content or the combined information on the basis of the URI of the acquired digital token or the like, and causes a content screen to be displayed. Furthermore, in the present embodiment, the combining means 211 to be described later performs display processing of combined digital content obtained by combining the combined information and the digital content. In addition, when a display processing request for the digital content is received directly or indirectly using the metadata URI, the display processing result of the digital content combined with the combined information may be transmitted on the basis of the digital content and the combined information. As a result, the user can browse the digital content combined with the combined information on the user terminal 3.

The display processing means 210 performs display processing of a plurality of providable digital tokens on the provision request screen in a selectable manner.

The selection reception means 206 receives the selection of the digital token.

The display processing means 210 performs display processing of the provision condition of the digital token selected by the user in the selection reception means 206 on the provision request screen. As a result, the user can easily confirm the provision condition of the digital token.

The display processing means 210 performs display processing of the provision request section of the digital token on the provision request screen. The display processing means 210 may perform display processing on the provision request section of the digital token in a differentiated manner based on the satisfaction status of the provision condition. The satisfaction status of the provision condition is determined by the determination means 203. For example, the provision request section of the digital token is displayed in a case where it is only necessary to visit one specific place and collate the position information of the place with the current location of the user, and the provision request section is not displayed in a case where it is necessary to visit a plurality of places and perform collation. In addition, a form is conceivable in which the color of the provision request section varies depending on the number of places with which the position information needs to be collated.

### Combined Information Reception Means

The combined information reception means 209 receives combined information. Furthermore, the combined information can be received at either timing before or after the digital token is acquired. Furthermore, the received combined information may be stored in the database 201.

### Combining Means

When the combined information reception means 209 receives the combined information, the combining means 211 creates combined digital content obtained by combining the digital content and the combined information. The combined digital content is associated with the digital token ID. The combined digital content is obtained by combining combined information such as a date, a text, and handwritten data freely drawn by the user on digital content of an image or a video. The combined digital content obtained by combination or the URI that allows browsing of the combined digital content may be stored in the database 201.

### User-Provided Data Reception Means

The user-provided data reception means 212 receives user-provided data from the user. Furthermore, the user-provided data can be received at either timing before or after the digital token is acquired. The user-provided data is associated with the digital token ID. Furthermore, the received user-provided data or the URI that allows browsing of the received user-provided data may be stored in the database 201.

### Pre-Transfer Reception Means

From a proxy user who collates a current location with position information as proxy for someone, the pre-transfer reception means 213 receives, on the provision request screen, a transfer destination user, who desires to receive transfer in advance, and a digital token, which the proxy user desires to transfer to the transfer destination user, among providable digital tokens. In principle, the digital token of a specific place is not provided without collating the position information of the place with the current location of the user who has visited the place. As an exception, in a case where the proxy user specifies the transfer destination user who desires to receive transfer and the providable digital token in advance, visits a place where the digital token is provided as proxy for the transfer destination user, and collates the current location of the proxy user with the position information, the digital token may be provided to the transfer destination user.

### Transfer Transmission Means

In a case where the determination means 203 determines that the provision condition is satisfied, the transfer transmission means 214 transmits a provision instruction of the digital token to the blockchain network system. As the provision instruction, the wallet address of the transfer destination user is transmitted instead of the wallet address of the proxy user. As a result, it is possible to adopt a form in which the transfer of the digital token is permitted with limitation.

In addition, before the provision instruction of the digital token is transmitted to the blockchain network system, a combination of the proxy user, the transfer destination user, and the digital token desired to be transferred to the transfer destination user is stored in the database 201. At a later date, a form is conceivable in which in a case where the transfer instruction of the proxy user for the digital token matches the combination, the transfer instruction may be transmitted to the blockchain network system.

### Retrieval Means

The retrieval means 215 retrieves peripheral position information on the basis of the position information indicating the current location of the user and the provision condition of the digital token. The peripheral position information is position information of a providable digital token to be provided around the current location of the user. As a result, it is possible to retrieve a digital token to be provided around the current location of the user.

The retrieval means 215 may retrieve the peripheral position information on the basis of the current location of the user, the attribute specified by the user, and the position information indicating the provision condition of the digital token, and the attribute associated with each digital token. The user can specify the attribute on the user basic information management screen. As a result, it is possible to retrieve the digital token that is present around the current location of the user and has the attribute specified by the user.

When a certain user retrieves the peripheral position information, the retrieval means 215 may retrieve the peripheral position information on the basis of the current location and the user attribute of the certain user, and the position information indicating the provision condition of the digital token, and the user attribute associated with the digital token. As a result, it is possible to retrieve the digital token that is present around the current location of the user, has the same user attribute, and is frequently acquired by the user.

### Notification Means

The notification means 216 notifies the user of the peripheral position information. The peripheral position information is position information retrieved by the retrieval means 215. As a result, the user can learn the position information of the digital token to be provided around the current location. Furthermore, the user may be notified of description information. The description information is an advertisement of the digital token or a text, an image, a video, or the like for description.

### Payment Determination Means

The payment determination means 217 determines whether payment made by the user is successful. Furthermore, satisfaction of the payment made by the user may be determined, and in a case where the payment is satisfied, receipt data may be provided. The provided receipt data or the URI that allows browsing of the receipt data may be stored in the database 201 in association with the digital token acquired through payment.

The payment determination means 217 may determine whether the payment made by the user is possible. Determination on whether or not the payment made by the user is possible means determination on whether or not a balance or the like recharged by the user is recorded in the user basic information, and a digital token or digital content in which a certain fee is stored can be acquired within a range of the balance. Based on this determination, the display processing means 210 may perform the display processing on the provision request section in a differentiated manner.

### Certificate Provision Means

The certificate provision means 218 provides certificate data indicating that the user holds the digital token. The provided certificate data or the URI that allows browsing of the certificate data may be stored in the database 201. As a result, even in a case where the user provides the digital token held by the user to another user, it is possible to prove that the user has held the digital token in the past.

Note that in the present embodiment, the configuration in which the server 2 is realized by a single computer device has been described, but the present invention is not limited thereto. For example, a configuration in which the server 2 is realized by a plurality of computer devices may be made, such as a configuration in which the determination means 203 is provided in another computer device.

### Processing of Providing Digital Token

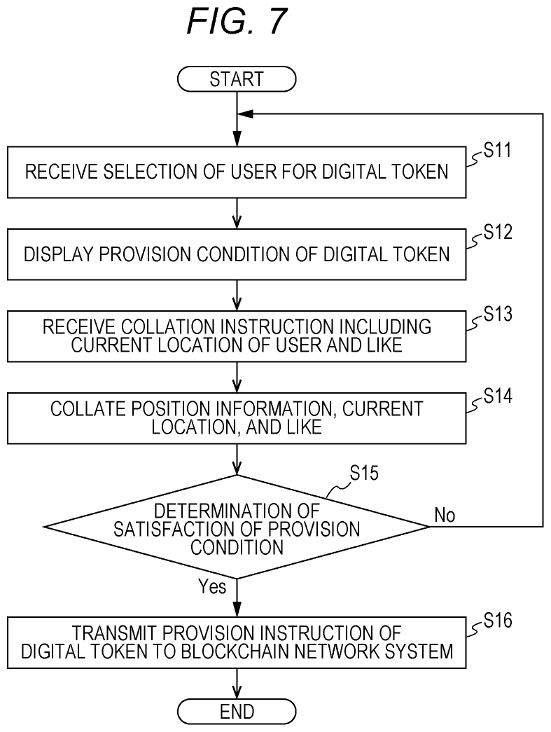

FIG. 7 is a flowchart illustrating a flow of processing of providing a digital token in the present embodiment. In step S11, the reception means 202 receives selection of the user for a providable digital token from a dedicated application downloaded to the user terminal 3.

In step S12, the display processing means 210 displays a provision condition of the digital token selected in step S11. Further, in step S12, the display processing means 210 displays a provision request section of the digital token for transmitting a collation instruction including the current location of the user. Further, when the selection of the user for the digital token is received, the determination means 203 may determine satisfaction of the provision condition of the digital token selected by the user, and on the basis of the result, the display processing means 210 may perform display processing on the provision request section of the digital token in a differentiated manner based on the satisfaction status of the provision condition.

In step S13, when the user presses the provision request section displayed on the screen of the dedicated application, a collation instruction including the current location of the user is transmitted to the server 2. Note that an embodiment is also conceivable in which the collation instruction including the current location of the user is transmitted to the server 2 by the selection for the digital token in step S11.

Further, the collation instruction may include information used for data collation. For example, a form is conceivable in which when the digital token is selected in step S11, a button for activating a camera may be displayed together with the provision condition of the digital token in the dedicated application. By pressing the button to activate the camera and reading a two-dimensional code, the current location of the user and the information used for data collation are transmitted. In addition, a form is conceivable in which a button for activating a camera displayed on a dedicated application is pressed and a two-dimensional code is read, so that the current location of the user and information used for data collation are transmitted. In addition, a form is conceivable in which after the transmission of the current location of the user from the user terminal 3 and the collation in the server, the server transmits an instruction to read the two-dimensional code to the user terminal 3, and a collation instruction including the information used for data collation is transmitted from the user terminal 3.

Furthermore, a form is conceivable in which when the digital token is selected in step S11, a request instruction for connection of near field communication is displayed on the user terminal 3, and when connection is made, the current location of the user and information acquired by the connection of near field communication are transmitted. Furthermore, a mode is also conceivable in which when the dedicated application is activated and the connection of near field communication is made, the current location of the user and the information acquired by the connection of near field communication are transmitted. In addition, a form is conceivable in which after the transmission of the current location of the user from the user terminal 3 and the collation in the server, the server transmits an instruction for the connection of near field communication to the user terminal 3, and a collation instruction including the information acquired by the connection of near field communication is transmitted from the user terminal 3.

Furthermore, in step S13, the collation instruction may be transmitted, and the user may transmit at least one of the user-provided data or the combined information. In addition, after the digital token and the digital content are acquired, at least one of the user-provided data or the combined information may be transmitted.

In step S14, the position information, the current location of the user, and the like are collated. In addition to the collation of the position information and the current location of the user, an acquisition order, an acquisition count, an acquirable period, an acquirable time, information used for data collation, success or failure of payment, and the like may be used for collation.

In step S15, it is determined whether the provision condition of the digital token is satisfied. Whether the collation of the position information stored as the provision condition of the digital token and the current location of the user is successful is determined. In addition to this determination of satisfaction, the acquisition order, the acquisition count, the acquirable period, the acquirable time, the information used for data collation, the success or failure of payment, and the like are also used for the determination of satisfaction. In a case where the determination of satisfaction of the provision condition is affirmative in step S15 (step S15: Yes), the process proceeds to step S16. In a case where the determination of satisfaction of the provision condition is negative in step S15 (step S15: No), the process waits for the user to select a digital token again.

In step S16, a provision instruction of the digital token is transmitted to the blockchain network system.

### Collation of Current Location and Position Information by Proxy

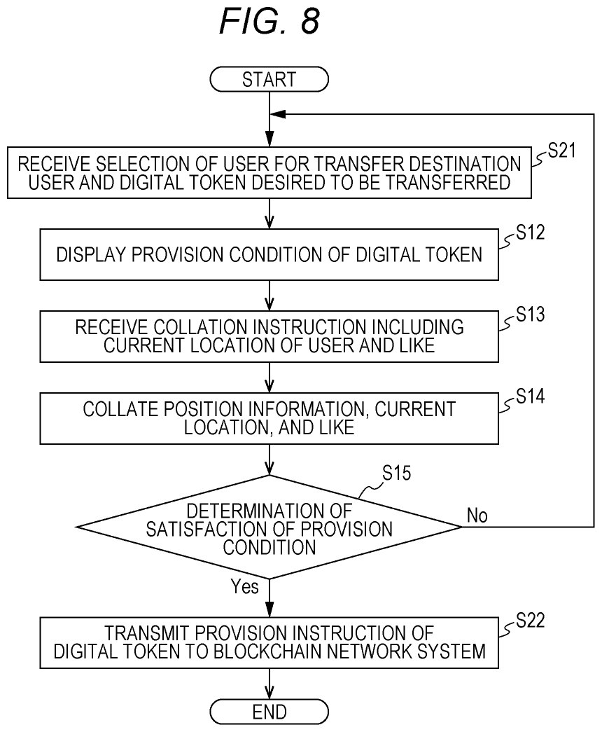

FIG. 8 is a diagram illustrating an example of a flow of processing of collating the current location and the position information and transferring a digital token via the user as a proxy in the present embodiment. In S21, the user selects a transfer destination user and a digital token desired to be transferred, and the pre-transfer reception means 213 receive the selection.

In step S22, a provision instruction of the digital token is transmitted to the blockchain network system. Since a user who receives the provision is the transfer destination user unlike step S16, a wallet address is stored in the blockchain.

### Case Where Provision Condition Includes Acquirable Time

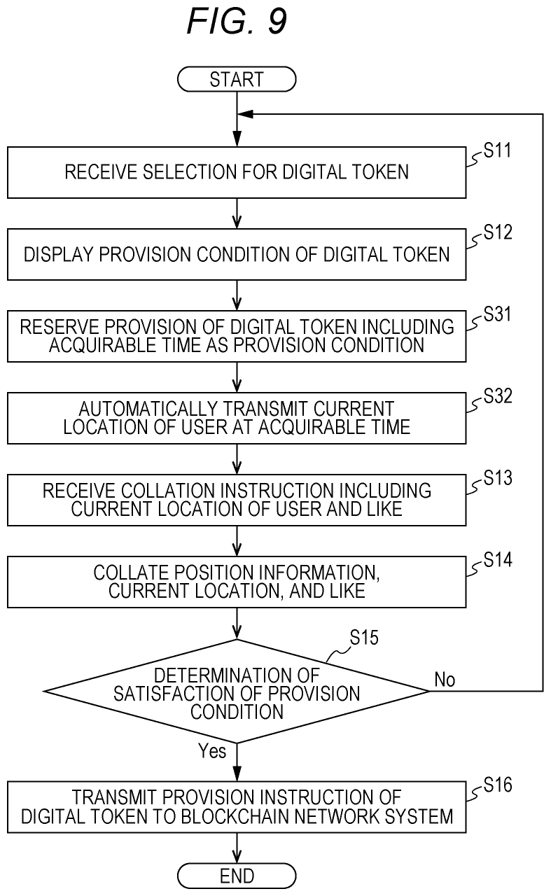

FIG. 9 is a diagram illustrating an example of a flow of processing of reserving provision of a digital token including an acquirable time as a provision condition in the present embodiment. In step S31, the user reserves the provision of the digital token including the acquirable time as a provision condition. The dedicated application stores the current location of the user to be transmitted at the acquirable time.

In step S32, when the user activates the dedicated application before the acquirable time, the dedicated application automatically transmits the current location of the user to the reception means 202 at the acquirable time.

### Notification of Peripheral Position Information

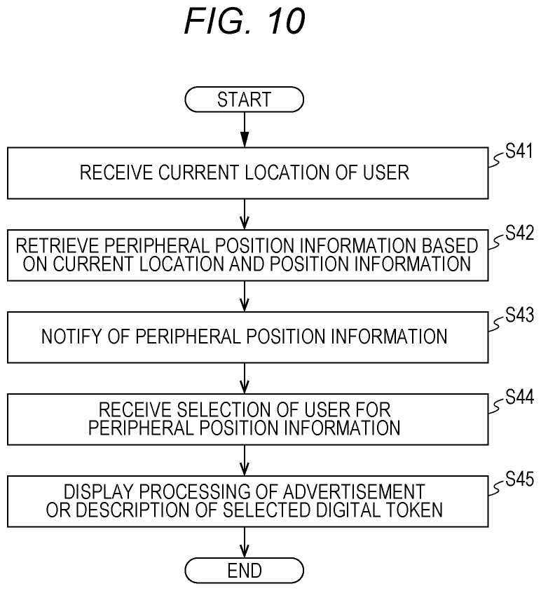

FIG. 10 is a diagram illustrating an example of a flow of processing of retrieving, notifying, and displaying peripheral position information in the present embodiment. In step S41, the user terminal 3 transmits the current location of the user to the server 2.

In step S42, the retrieval means 215 retrieves the peripheral position information by using the received current location and the position information of the digital token stored in the database.

In step S42, the retrieval means 215 may further retrieve the peripheral position information by using the attribute specified by the user and the digital token attribute indicating the position information associated with the digital token. The attribute specified by the user is highly likely to be related to what the user is interested in. That is, when the attribute is included to retrieve the peripheral position information, there is a high possibility that the digital token of interest of the user can be presented by transmitting the current location.

In addition, the retrieval means 215 may retrieve the peripheral position information by using the user attribute of the user who has transmitted the current location and the position information. From the user history information, the user attributes of users who favor a certain providable token is popular can be determined. Therefore, when the peripheral position information is retrieved by using the user attribute of the user who has transmitted the current location and the user history information, there is a high possibility that the digital token of interest of the user who has transmitted the current location can be presented.

In step S43, the notification means 216 notifies the user of the peripheral position information.

In step S44, the reception means 202 receives the selection of the user for the peripheral position information.

In step S45, the notification means 216 performs display processing of the advertisement or the description of the digital token of the selected peripheral position information.

Note that data transmission/reception, requests, and the like between the server 2 and the user terminal 3 and the like in the present embodiment may be performed via a browser application related to the user terminal 3 or may be performed via an API.

### REFERENCE SIGNS LIST

1 Digital token issuing system
2 Server
3 User terminal
4 Blockchain network system
201 Database
202 Reception means
203 Determination means
204 Transmission means
205 Reservation reception means
206 Selection reception means
209 Combined information reception means
210 Display processing means
211 Combining means
212 User-provided data reception means
213 Pre-transfer reception means
214 Transfer transmission means
215 Retrieval means
216 Notification means
217 Payment determination means
218 Certificate provision means
301 Current location transmission means

1. A digital token provision system that provides a digital token, the digital token provision system comprising:
a database; a reception means; a determination means; and a transmission means, wherein
the database stores position information as a provision condition of a digital token,
the reception means receives a collation instruction including a current location of a user,
the determination means determines satisfaction of the provision condition by using a collation result of the position information and the current location, and
the transmission means transmits a provision instruction of a digital token to a blockchain network system in a case where the provision condition is satisfied.

2. The digital token provision system according to claim 1, wherein
the database further stores at least one of an acquisition order, an acquisition count, or an acquirable period as a provision condition of the digital token,
the acquisition order is an order of position information that needs to be collated in order to acquire the digital token or an acquisition order of a digital token that needs to be acquired,
the acquisition count is a count of position information that needs to be collated in order to acquire the digital token or an acquisition count of the digital token that needs to be acquired,
the acquirable period is a period in which the digital token is acquirable, and
the determination means further determines satisfaction of the provision condition by using at least one of a collation history of the position information of the user and the acquisition order, the collation history of the position information of the user and the acquisition count, an acquisition history of the digital token of the user and the acquisition order, the acquisition history of the digital token of the user and the acquisition count, or the collation result of current date and time and the acquirable period.

3. The digital token provision system according to claim 1, further comprising:
a reservation reception means, wherein
the reservation reception means receives a reservation for provision of a digital token, and
the determination means determines satisfaction of the provision condition by using a collation result of position information of the digital token for which the reservation has been received and the current location.

4. The digital token provision system according to claim 3, further comprising:
a current location transmission means, wherein
the database further includes an acquirable time as a provision condition of the digital token, and
the current location transmission means transmits the current location to the reception means at the acquirable time.

5. The digital token provision system according to claim 2, further comprising:
a selection reception means; and a display processing means, wherein
the selection reception means receives selection for the digital token, and
the display processing means performs display processing of the provision condition of the selected digital token.

6. The digital token provision system according to claim 2, further comprising:
a display processing means, wherein
the determination means determines the satisfaction of the provision condition of the digital token on a basis of at least one of the collation history of the position information of the user and the acquisition order, the collation history of the position information of the user and the acquisition count, the acquisition history of the digital token of the user and the acquisition order, the acquisition history of the digital token of the user and the acquisition count, or the collation result of the current date and time and the acquirable period, and
the display processing means performs display processing of a provision request section of the digital token in a differentiated manner based on a satisfaction status of the provision condition.

7. The digital token provision system according to claim 1, wherein
the database further stores, as the provision condition of the digital token, information acquired by reading of a two-dimensional code or connection of near field communication, and
when the reception means receives a collation instruction including the information acquired by reading of a two-dimensional code by the user or connection of near field communication,
the determination means determines satisfaction of the provision condition by using a collation result between the information stored in the database and the information acquired by the reception means.

8. The digital token provision system according to claim 1, wherein
the database further stores digital content to be provided to a user in association with position information,
the digital content is an image or a video, and
the transmission means transmits, to the blockchain network system, the provision instruction including the digital content or a URI that allows browsing of the digital content in a case where the provision condition is satisfied.

9. The digital token provision system according to claim 8, further comprising:
a combined information reception means; and a display processing means, wherein
the combined information reception means further receives combined information,
the database stores the combined information in association with a URI for browsing the digital content,
the combined information is a date, a text, or handwritten data freely drawn by the user, and
when receiving a display processing request of the digital content directly or indirectly by using the URI, the display processing means transmits a display processing result of the digital content in which the combined information is combined, on a basis of the digital content and the combined information.

10. The digital token provision system according to claim 8, further comprising:
a combined information reception means; and a combining means, wherein
the combined information reception means further receives combined information,
the combining means creates combined digital content obtained by combining the digital content and the combined information,
the combined information is a date, a text, or handwritten data freely drawn by the user, and
after the combining, the transmission means transmits, to a blockchain network system, the provision instruction including the combined digital content or the URI that allows browsing of the combined digital content.

11. The digital token provision system according to claim 1, further comprising:
a user-provided data reception means, wherein
the user-provided data reception means receives user-provided data,
the user-provided data is at least one of text, a photograph, or a video, and
the transmission means further transmits, to the blockchain network system, the provision instruction including the user-provided data or a URI that allows browsing of the user-provided data in a case where the provision condition is satisfied.

12. The digital token provision system according to claim 1, further comprising:
a pre-transfer reception means; and a transfer transmission means, wherein
from a proxy user who collates a current location with the position information as proxy for someone, the pre-transfer reception means receives a transfer destination user, who desires to receive transfer in advance, and a digital token, which the proxy user desires to transfer to the transfer destination user, among providable digital tokens, and
the transfer transmission means transmits a provision instruction of the digital token to the blockchain network system in a case where the provision condition is satisfied.

13. The digital token provision system according to claim 1, further comprising:
a retrieval means; and a notification means, wherein
the retrieval means retrieves peripheral position information on a basis of a current location of the user and position information indicating a provision condition of the digital token,
the peripheral position information is position information of a digital token provided around the current location of the user, and
the notification means notifies the user of the peripheral position information.

14. The digital token provision system according to claim 13, wherein
the database further stores an attribute specified by the user and an attribute associated with each digital token, and
the retrieval means further retrieves peripheral position information on a basis of the current location of the user, the attribute specified by the user, the position information indicating the provision condition of the digital token, and the attribute associated with each digital token.

15. The digital token provision system according to claim 13, wherein
the database further stores a user attribute of the user in association with the digital token each time the user collates the position information or acquires the digital token, and
when a certain user retrieves the peripheral position information, the retrieval means further retrieves the peripheral position information on a basis of a current location and a user attribute of the certain user.

16. The digital token provision system according to claim 13, wherein
the database further stores description information in association with the digital token,
the description information is an advertisement of the digital token or a text, an image, or a video for description, and
the notification means further notifies the user of the description information.

17. The digital token provision system according to claim 1, further comprising:
a payment determination means, wherein
the provision condition includes success or failure of payment,
the payment determination means determines success or failure of payment made by the user, and
the transmission means transmits the provision instruction of the digital token to the blockchain network system in a case where the provision condition is satisfied.

18. The digital token provision system according to claim 17, wherein
the payment determination means further determines satisfaction of payment made by the user, and provides receipt data in a case where the payment is satisfied, and
the transmission means further transmits, to the blockchain network system, the provision instruction including the receipt data or a URI that allows browsing of the receipt data.

19. The digital token provision system according to claim 1, further comprising:
a payment determination means; and a display processing means, wherein
the payment determination means determines whether or not payment made by the user is possible, and
the display processing means performs display processing of a provision request section of the digital token so as to distinguish between a case where the payment made by the user is possible and a case where the payment is impossible.

20. The digital token provision system according to claim 1, further comprising:
a certificate provision means, wherein
the certificate provision means provides certificate data indicating that a user holds a digital token, and
the transmission means further transmits, to the blockchain network system, the provision instruction including the certificate data or a URI that allows browsing of the certificate data.

21. The digital token provision system according to claim 1, wherein
the digital token is a non-fungible token.

22. A non-transitory computer readable medium which stores a digital token provision program for providing a digital token, the digital token provision program causing a computer to function as:
a database; a reception means; a determination means; and a transmission means, wherein
the database stores in advance a provision condition of a digital token including position information,
the reception means receives a collation instruction including a current location of a user,
the determination means determines satisfaction of the provision condition by using a collation result of the position information and the current location, and
the transmission means transmits a provision instruction of a digital token to a blockchain network system in a case where the provision condition is satisfied.

23. A digital token provision method for providing a digital token, the method comprising:
by a digital token provision system including a database, executing: a reception step; a determination step; and a transmission step, wherein
the database stores in advance a provision condition of a digital token including position information,
in the reception step, a collation instruction including a current location of a user is received,
in the determination step, satisfaction of the provision condition is determined by using a collation result of the position information and the current location, and
in the transmission step, a provision instruction of a digital token is transmitted to a blockchain network system in a case where the provision condition is satisfied.
